(19) United States
(12) Patent Application Publication
(10) Pub. No.: US 2026/0140795 A1
(43) Pub. Date: May 21, 2026

(54) Sharing Model Weights in a Hardware Accelerator

(71) Applicant: INTERNATIONAL BUSINESS MACHINES CORPORATION, ARMONK, NY (US)

(72) Inventors: Volkmar UHLIG, AUSTIN, TX (US); Christian JACOBI, WEST PARK, NY (US); Hillery HUNTER, CHAPPAQUA, NY (US)

(21) Appl. No.: 18/940,125

(22) Filed: Nov. 7, 2024

(51) Int. Cl. G06F 9/54; G06N 20/00

(52) U.S. Cl. CPC G06F 9/544; G06N 20/00

(57) ABSTRACT

Sharing model weights in a hardware accelerator, including: loading, in response to a request associated with a first user, a plurality model weights into a hardware accelerator; receiving a request associated with a second user to load the plurality of model weights into the hardware accelerator; and sharing, for the first user and the second user, access to the plurality of model weights in a shared memory space of the hardware accelerator.

### BACKGROUND

The present disclosure relates to methods, apparatus, and products for sharing model weights in a hardware accelerator.

### SUMMARY

According to embodiments of the present disclosure, various methods, apparatus and products for sharing model weights in a hardware accelerator are described herein. In some aspects, sharing model weights in a hardware accelerator includes loading, in response to a request associated with a first user, a plurality model weights into a hardware accelerator; receiving a request associated with a second user to load the plurality of model weights into the hardware accelerator; and sharing, for the first user and the second user, access to the plurality of model weights in a shared memory space of the hardware accelerator. In some aspects, an apparatus may include a processing device; and memory operatively coupled to the processing device, wherein the memory stores computer program instructions that, when executed, cause the processing device to perform this method. In some aspects, a computer program product comprising a computer readable storage medium may store computer program instructions that, when executed, perform this method.

### BRIEF DESCRIPTION OF THE DRAWINGS

FIG. 1 sets forth a block diagram of an example computing environment for sharing model weights in a hardware accelerator in accordance with some embodiments of the present disclosure.

FIG. 2 sets forth a flowchart of an example method of sharing model weights in a hardware accelerator in accordance with some embodiments of the present disclosure.

FIG. 3 sets forth a flowchart of another example method of sharing model weights in a hardware accelerator in accordance with some embodiments of the present disclosure.

FIG. 4 sets forth a flowchart of another example method of sharing model weights in a hardware accelerator in accordance with some embodiments of the present disclosure.

FIG. 5 sets forth a flowchart of another example method of sharing model weights in a hardware accelerator in accordance with some embodiments of the present disclosure.

FIG. 6 sets forth a flowchart of another example method of sharing model weights in a hardware accelerator in accordance with some embodiments of the present disclosure.

FIG. 7 sets forth a flowchart of another example method of sharing model weights in a hardware accelerator in accordance with some embodiments of the present disclosure.

### DETAILED DESCRIPTION

Hardware accelerators such as graphics processing units (GPUs) or artificial intelligence (AI) accelerators may be used to improve speed and/or computational efficiency when executing trained models. These models may include generative AI models such as large language models (LLMs) or other models as can be appreciated. To do so, the models, including the weights of those models, are loaded into the memory of the hardware accelerator. Existing implementations of hardware accelerators may not enable memory sharing such that multiple users may access the same data as stored in the hardware accelerator. Thus, in order to allow multiple users to execute the same or similar models in a hardware accelerator, multiple instances of those models must be loaded in memory. This may restrict the overall number of models that may be loaded into the hardware accelerator at a given time.

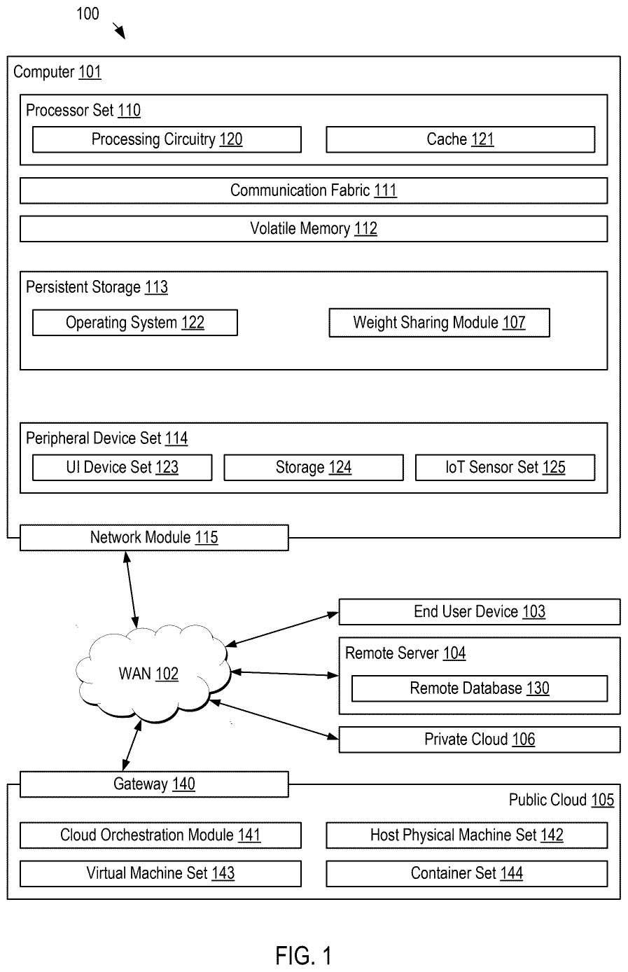

With reference now to FIG. 1, shown is an example computing environment according to aspects of the present disclosure. Computing environment 100 contains an example of an environment for the execution of at least some of the computer code involved in performing the various methods described herein, such as a weight sharing module 107. In addition to the weight sharing module 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in block 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

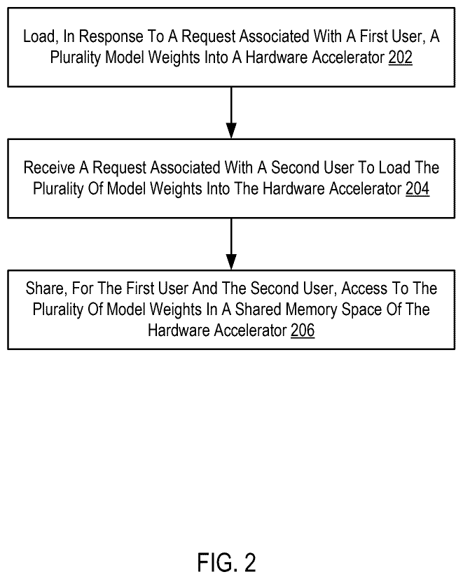

FIG. 2 sets forth a flowchart of an example method of sharing model weights in a hardware accelerator in accordance with some embodiments of the present disclosure. The method of FIG. 2 may be performed, for example, by a weight sharing module 107 of FIG. 1. The method of FIG. 2 includes loading 202, in response to a request associated with a first user, a plurality of model weights into a hardware accelerator. As referred to herein, a hardware accelerator is a dedicated hardware component of a computing system designed to perform specific functions more efficiently when compared to running on a general-purpose processing unit. For example, in some embodiments, the hardware accelerator may include a graphics processing unit (GPU), an artificial intelligence (AI) accelerator, or another hardware accelerator as can be appreciated. Here, the hardware accelerator includes some amount of dedicated memory into which the plurality of model weights will be loaded.

The plurality of model weights includes the weights of a trained model. Such a trained model may include, for example, a generative AI model such as a large language model (LLM) or other trained machine learning models as can be appreciated. The plurality of model weights are weights of the trained model used in generating inferences or other output by the trained model. For example, the plurality of model weights may include weights of various layers of the trained model. In some embodiments, the plurality of model weights may be encoded as matrices or other data structures for encoding these layers. Accordingly, the request associated with the first user may include a request (e.g., from the first user or a process executed in association with the first user) to load the trained model, and by virtue the plurality of model weights, into the hardware accelerator so that the hardware accelerator may run the trained model to generate some output.

Here, the request is associated with a first user. Accordingly, the hardware accelerator may be a component in a multi-user system such as a mainframe, a computing system implementing multiple virtual machines each with their respective users, and the like. Thus, the request associated with the first user causes the plurality of model weights to be loaded into the hardware accelerator to perform some function in association with the first user.

The method of FIG. 2 also includes receiving 204 a request associated with a second user to load the plurality of model weights into the hardware accelerator. Here, the request may include a request from the second user or a process associated with the second user to load some model into the hardware accelerator. In some embodiments, the request associated with the second user may include a request to load the same model into the hardware accelerator as the first user. In some embodiments, the request associated with the second user may include a request to load a model different than the first user that nonetheless shares the plurality of model weights.

For example, in some embodiments, low-rank adaptation of a model may allow new data to be trained into a given model without fully retraining the model by injecting adaptation matrices between the layers or transformer blocks of the model. Thus, a base model can be further trained or tailored to some data set using these adaptation matrices. The adapted model with then include the weights of the base model plus the additional adaptation matrices. Accordingly, in some embodiments, the request from the first user or the second user may include a request to load a base model into the hardware accelerator while the other request may include a request to load an adapted model based on the base model. In some embodiments, the request from the first user and the second user may include requests to load different adapted models based on the same base model that therefore share the weights of this base model.

The method of FIG. 2 also includes sharing 206, for the first user and the second user, access to the plurality of model weights in a shared memory space of the hardware accelerator. The shared memory space of the hardware accelerator includes some amount of memory that may be accessed by both the first user and the second user. As the plurality of model weights are stored into the shared memory space of the hardware accelerator, a single instance of the plurality of model weights may be stored in the hardware accelerator that may be accessed and used by both the first user and the second user. The specific approaches for sharing access to a single instance of the plurality of model weights across multiple users will be described in further detail below.

Readers will appreciate that, in some existing solutions for loading models into hardware accelerators for execution, hardware accelerators do not allow for shared memory that may be accessed by multiple users. In other words, each user attempting to load models into the hardware accelerator will be allocated their own exclusive memory space in the hardware accelerator. Thus, should multiple users wish to load the same model into a hardware accelerator, an instance of this model will be loaded into the hardware accelerator for each user. This approach is space-inefficient and restricts the number of models that may be loaded into the hardware accelerator at any given time.

In contrast, using the approaches set forth herein, a single instance of model weights may be loaded into a hardware accelerator for access and usage by multiple users. Thus, the overall amount of memory used in the hardware accelerator may be reduced, thereby allowing for greater numbers of models to be loaded into the hardware accelerator at a given time. Readers will appreciate that, although the examples set forth herein are presented in relation to a first and second user, the approaches set forth herein may be applied to any number of users and any number of models and/or sets of weights, depending on available resources.

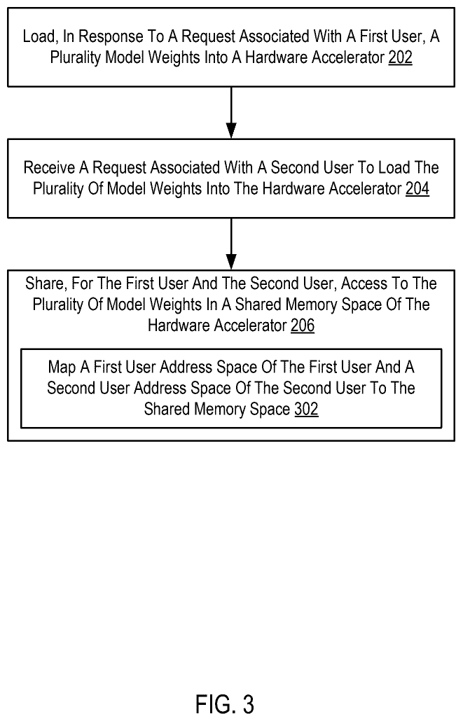

For further explanation, FIG. 3 sets forth a flowchart of another example method of sharing model weights in a hardware accelerator in accordance with some embodiments of the present disclosure. The method of FIG. 3 is similar to FIG. 2 in that the method of FIG. 3 also includes: loading 202, in response to a request associated with a first user, a plurality of model weights into a hardware accelerator; receiving 204 a request associated with a second user to load the plurality of model weights into the hardware accelerator; and sharing 206, for the first user and the second user, access to the plurality of model weights in a shared memory space of the hardware accelerator.

The method of FIG. 3 differs from FIG. 2 in that sharing 206, for the first user and the second user, access to the plurality of model weights in a shared memory space of the hardware accelerator also includes mapping 302 a first user address space of the first user and a second user address space of the second user to the shared memory space. A user address space is a virtual address space associated with a particular user. In other words, in some embodiments, a portion of a virtual address space associated with the first user and a portion of a virtual address space associated with the second user may both map to the same memory addresses on the hardware accelerator storing the plurality of model weights.

In some embodiments, an operating system-level command may allow mapping between a virtual address space and an address space of a hardware accelerator. Thus, memory accesses to the mapped portion of the virtual address space will access the mapped portions of the address space of the hardware accelerator. Accordingly, in some embodiments, the requests from the first and second user may include such an operating system-level command to load the plurality of model weights from some memory location (e.g., disk space) into the hardware accelerator and map the portion of memory of the hardware accelerator storing the plurality of model weights to the virtual address space of the respective user.

Here, such an operating system-level command will communicate with the hardware accelerator to load data into the hardware accelerator. In some embodiments, drivers and/or firmware for the hardware accelerator will handle the loading of data into the hardware accelerator. For example, where the data indicated in some command is not stored in the hardware accelerator the drivers and/or firmware of the hardware accelerator will handle loading of this data into the memory of the hardware accelerator and provide, in response to the command, an indication of where the data is stored on the hardware accelerator so that it can be mapped to the virtual address space. Where the data is already stored in the hardware accelerator, an indication of where the data is already stored on the hardware accelerator may be provided in response. Where a command requests that some additional data be loaded into the hardware accelerator in addition to some data that is already stored, such as adaptation matrices, this additional data may be loaded in response to the command. Accordingly, a response to the command may indicate both where the data that was already stored in the hardware accelerator is stored as well as where the newly loaded additional data is stored in the hardware accelerator.

Readers will appreciate that, by using such an operating system-level command, memory management may be delegated to the hardware accelerator and the operating system. Moreover, as the operating system has knowledge of how much and how memory of the hardware accelerator is shared across users, this may assist in resource accounting or other functions.

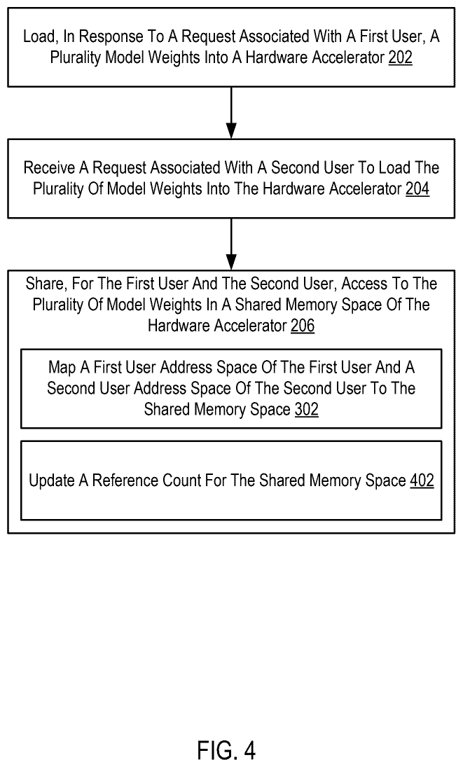

For further explanation, FIG. 4 sets forth a flowchart of another example method of sharing model weights in a hardware accelerator in accordance with some embodiments of the present disclosure. The method of FIG. 4 is similar to FIG. 3 in that the method of FIG. 4 also includes: loading 202, in response to a request associated with a first user, a plurality of model weights into a hardware accelerator; receiving 204 a request associated with a second user to load the plurality of model weights into the hardware accelerator; and sharing 206, for the first user and the second user, access to the plurality of model weights in a shared memory space of the hardware accelerator, including: mapping 302 a first user address space of the first user and a second user address space of the second user to the shared memory space.

The method of FIG. 4 differs from FIG. 3 in that sharing 206, for the first user and the second user, access to the plurality of model weights in a shared memory space of the hardware accelerator also includes updating 402 a reference count for the shared memory space. A reference count for some portion of memory tracks the number of mappings to that portion of memory. This may correspond to the number of users and/or processes having access to this portion of memory using virtual memory addresses. In some embodiments, the operating system may maintain the reference count for memory of the hardware accelerator and therefore the shared memory space. In some embodiments, the hardware accelerator itself may maintain the reference count.

Accordingly, updating 402 the reference count for the shared memory space may include incrementing the reference count by virtue of a user address space of the second user being mapped to the shared memory space. For example, where both the first and second user address spaces are mapped to the shared memory space, the reference count may be equal to two. Should any other user address spaces be mapped to the shared memory space, the reference count may reflect those other user address spaces.

Readers will appreciate that, should commands from the first or second user free the mapping of their virtual address spaces to the shared memory space, the reference count may be decremented. As long as the shared memory space has a non-zero reference count, the shared memory space may not be overwritten or deleted.

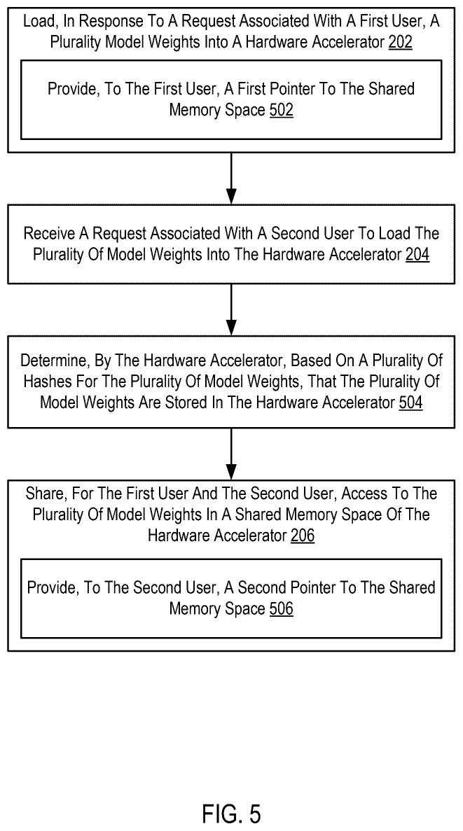

For further explanation, FIG. 5 sets forth a flowchart of another example method of sharing model weights in a hardware accelerator in accordance with some embodiments of the present disclosure. The method of FIG. 5 is similar to FIG. 2 in that the method of FIG. 5 also includes: loading 202, in response to a request associated with a first user, a plurality of model weights into a hardware accelerator; receiving 204 a request associated with a second user to load the plurality of model weights into the hardware accelerator; and sharing 206, for the first user and the second user, access to the plurality of model weights in a shared memory space of the hardware accelerator.

The method of FIG. 5 differs from FIG. 2 in that loading 202, in response to a request associated with a first user, a plurality of model weights into a hardware accelerator includes providing 502, to the first user, a pointer to the shared memory space. In some embodiments, the request associated with the first user may include a request for a pointer to where the plurality of model weights are stored in the memory of the hardware accelerator. For example, the plurality of model weights may be loaded into host memory of the first user and hashes may be calculated for the plurality of model weights. This may include subdividing the plurality of model weights into portions and calculating a hash for each function using a hash function with a low probability of collision such as SHA 256. The request for the pointer may be sent to the hardware, asking for a pointer to where data matching these hashes are stored in the memory of the hardware accelerator. Here, assume that the plurality of model weights are not stored in the hardware accelerator. Accordingly, the hardware accelerator may provide an error in response, indicating that no data matching these hashes is stored in the memory of the hardware accelerator. This may cause the plurality of model weights to be loaded into the hardware accelerator by allocating memory in the hardware accelerator for storage. The hardware accelerator may calculate hashes for the plurality of model weights as stored and compare them to the previously received hashes. Where the hashes do not match, indicating that some other data was loaded into memory, the hardware accelerator may reject and delete this other data. Otherwise, the hardware accelerator may provide 502 the pointer to the shared memory space storing the plurality of model weights.

The method of FIG. 5 also includes determining 504, by the hardware accelerator, based on a plurality of hashes for the plurality of model weights, that the plurality of model weights are stored in the hardware accelerator. Here, the request associated with the second user may be similar to the request associated with the first user in that it includes a request to load the plurality of model weights from memory into the hardware accelerator and expects, in response, a pointer to where the plurality of model weights are stored in the hardware accelerator. Here, in order to share 206 access to the plurality of model weights, it must be determined that the plurality of model weights are stored in the hardware accelerator.

In some embodiments, determining 504 that the plurality of model weights are stored in the hardware accelerator may include loading the plurality of model weights into host memory of the second user and hashes calculated as described above. A request may be sent to the hardware accelerator requesting a pointer to data in the memory of the hardware accelerator that matches these hashes. As the plurality of model weights are already stored in the memory of the hardware accelerator a match will be found and the corresponding pointer returned by the hardware accelerator.

The method of FIG. 5 further differs from FIG. 2 in that sharing 206, for the first user and the second user, access to the plurality of model weights in a shared memory space of the hardware accelerator includes providing 506, to the second user, a second pointer to the shared memory space. Thus, the first user and the second user may each access the plurality of model weights using pointers to the same portion of memory in the hardware accelerator.

Readers will appreciate that this approach provides advantages over the previously described approaches using operating system-level commands. For example, in an environment using multiple virtual machines, each virtual machine will use its own instance of an operating system. Accordingly, mappings to the memory of the hardware accelerator would not cross virtual machine boundaries, preventing different virtual machines from sharing access to the same instance of the plurality of weights in the hardware accelerator. In contrast, the approaches described above will allow for pointers to be provided to each of these virtual machines directed to the same area of memory, thereby allowing for sharing of the plurality of model weights across virtual machine boundaries.

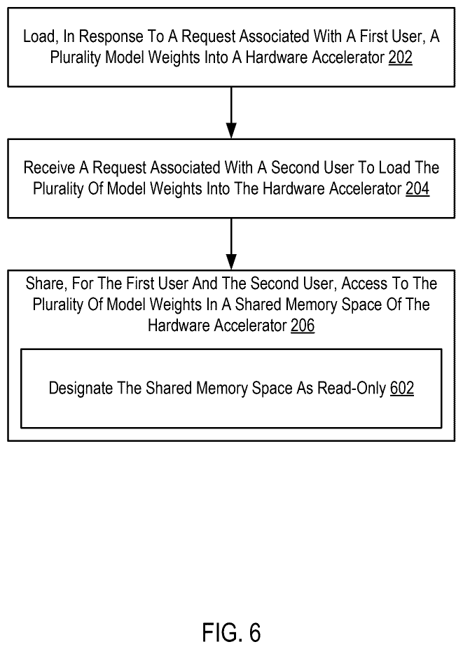

For further explanation, FIG. 6 sets forth a flowchart of another example method of sharing model weights in a hardware accelerator in accordance with some embodiments of the present disclosure. The method of FIG. 6 is similar to FIG. 2 in that the method of FIG. 6 also includes: loading 202, in response to a request associated with a first user, a plurality of model weights into a hardware accelerator; receiving 204 a request associated with a second user to load the plurality of model weights into the hardware accelerator; and sharing 206, for the first user and the second user, access to the plurality of model weights in a shared memory space of the hardware accelerator.

The method of FIG. 6 differs from FIG. 2 in that sharing 206, for the first user and the second user, access to the plurality of model weights in a shared memory space of the hardware accelerator also includes designating 602 the shared memory space as read-only. In other words, the portion of the memory of the hardware accelerator storing the shared instance of the plurality of model weights is designated as read-only. In some embodiments, the shared memory space may be designated as read-only in response to determining that multiple users are sharing access to the same data stored in the hardware accelerator.

Readers will appreciate that existing implementations of hardware accelerators may not implement read-only memory as they do not enable any sort of sharing across users or virtual address spaces. Accordingly, it may be necessary to designate data stored in the hardware accelerator having shared access as read-only to prevent unwanted errors due to one user manipulating the data.

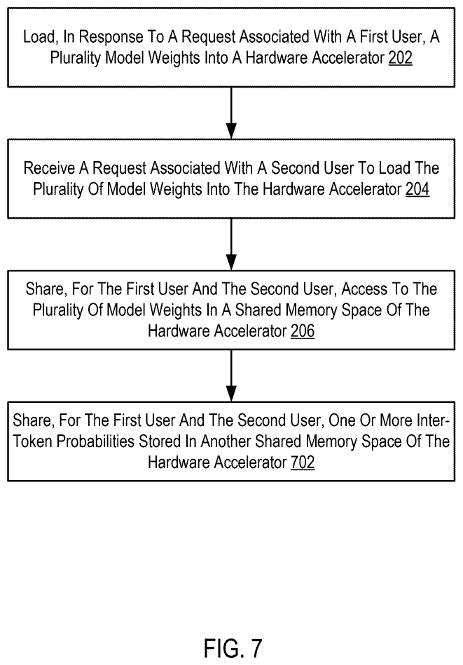

For further explanation, FIG. 7 sets forth a flowchart of another example method of sharing model weights in a hardware accelerator in accordance with some embodiments of the present disclosure. The method of FIG. 7 is similar to FIG. 2 in that the method of FIG. 7 also includes: loading 202, in response to a request associated with a first user, a plurality of model weights into a hardware accelerator; receiving 204 a request associated with a second user to load the plurality of model weights into the hardware accelerator; and sharing 206, for the first user and the second user, access to the plurality of model weights in a shared memory space of the hardware accelerator.

The method of FIG. 7 differs from FIG. 2 in that the method of FIG. 7 also includes sharing 702, for the first user and the second-user, one or more inter-token probabilities stored in another shared memory space of the hardware accelerator. During execution of LLMs or other generative AI models (e.g., to generate some output), inter-token probabilities are calculated across each layer of the model. Where the same model is used to generate an output based on two different inputs, if some initial portion of these different inputs are the same, some amount of the initial inter-token probabilities for these different inputs will also be the same. For example, assume that inputs to an LLM include a prompt based on a prompt template, where the prompt template is predefined and some additional data is added or populated in order to generate the prompt. Here, the initial portions of calls to this LLM will be identical up to the point where some additional or populated data is included.

Accordingly, one or more inter-token probabilities may also be stored in some portion of memory of the hardware accelerator accessible to multiple users, such as a cache. Thus, some amount of inter-token probabilities calculated for a call to a model by given user may be reused for calls to a model by another user. This may improve overall memory usage for the hardware accelerator and may accelerate overall performance when executing models as some amount of inter-token probabilities need not be recalculated.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
loading, in response to a request associated with a first user, a plurality model weights into a hardware accelerator;
receiving a request associated with a second user to load the plurality of model weights into the hardware accelerator; and
sharing, for the first user and the second user, access to the plurality of model weights in a shared memory space of the hardware accelerator.

2. The method of claim 1, wherein the hardware accelerator comprises a graphics processing unit (GPU).

3. The method of claim 1, wherein the hardware accelerator comprises an artificial intelligence (AI) accelerator.

4. The method of claim 1, wherein the request associated with the first user and the request associated with the second user each comprise a command to map the plurality of model weights in the hardware accelerator to a user address space.

5. The method of claim 4, wherein sharing access to the plurality of model weights in the shared memory space of the hardware accelerator comprises mapping a first user address space of the first user and a second user address space of the second user to the shared memory space.

6. The method of claim 4, wherein sharing access to the plurality of model weights in the shared memory space of the hardware accelerator comprises updating a reference count for the shared memory space.

7. The method of claim 1, further comprising determining, by the hardware accelerator, based on a plurality of hashes for the plurality of model weights, that the plurality of model weights are stored in the hardware accelerator.

8. The method of claim 7:
wherein loading the plurality of model weights into the hardware accelerator comprises providing, to the first user, a first pointer to the shared memory space; and
wherein sharing access to the plurality of model weights in the shared memory space of the hardware accelerator comprises providing, to the second user, a second pointer to the shared memory space.

9. The method of claim 1, wherein the request associated with the first user and the request associated with the second user each comprise a request to load a same model into the hardware accelerator.

10. The method of claim 1, wherein the request associated with the first user comprises a request to load a first model into the hardware accelerator and the request associated with the second user comprises a request to load a second model into the hardware accelerator, wherein the first model and the second model are different models sharing a same base model.

11. The method of claim 1, wherein sharing access to the plurality of model weights in the shared memory space of the hardware accelerator comprises designating the shared memory space as read-only.

12. The method of claim 1, further comprising sharing, for the first user and the second user, one or more inter-token probabilities stored in another shared memory space of the hardware accelerator.

13. An apparatus comprising:
a memory;
a hardware accelerator; and
a processing device operatively coupled to the memory, the processing device configured to:
load, in response to a request associated with a first user, a plurality model weights into the hardware accelerator;
receive a request associated with a second user to load the plurality of model weights into the hardware accelerator; and
share, for the first user and the second user, access to the plurality of model weights in a shared memory space of the hardware accelerator.

14. The apparatus of claim 13, wherein the hardware accelerator comprises a graphics processing unit (GPU).

15. The apparatus of claim 13, wherein the hardware accelerator comprises an artificial intelligence (AI) accelerator.

16. The apparatus of claim 13, wherein the request associated with the first user and the request associated with the second user each comprise a command to map the plurality of model weights in the hardware accelerator to a user address space.

17. The apparatus of claim 16, wherein, to share access to the plurality of model weights in the shared memory space of the hardware accelerator, the processing device is configured to map a first user address space of the first user and a second user address space of the second user to the shared memory space.

18. The apparatus of claim 13, wherein the processing device is further configured to determine, by the hardware accelerator, based on a plurality of hashes for the plurality of model weights, that the plurality of model weights are stored in the hardware accelerator.

19. The apparatus of claim 18:
wherein, to load the plurality of model weights into the hardware accelerator, the processing device is configured to provide, to the first user, a first pointer to the shared memory space; and
wherein, to share access to the plurality of model weights in the shared memory space of the hardware accelerator, the processing device is configured to provide, to the second user, a second pointer to the shared memory space.

20. A computer program product comprising a computer readable storage medium, wherein the computer readable storage medium comprises computer program instructions that, when executed:
load, in response to a request associated with a first user, a plurality model weights into a hardware accelerator;
receive a request associated with a second user to load the plurality of model weights into the hardware accelerator; and
share, for the first user and the second user, access to the plurality of model weights in a shared memory space of the hardware accelerator.
